(19) United States
(12) Patent Application Publication
(10) Pub. No.: US 2026/0063925 A1
(43) Pub. Date: Mar. 5, 2026

(54) HIGH-REFRACTION GLASS HAVING LOW DENSITY

(71) Applicant: SCHOTT AG, Mainz (DE)

(72) Inventors: Sebastian LEUKEL, Mainz (DE); Simone Monika RITTER, Mainz (DE)

(21) Appl. No.: 19/310,110

(22) Filed: Aug. 26, 2025

(30) Foreign Application Priority Data
Sep. 3, 2024 (DE) 10 2024 125 122.0
Jul. 24, 2025 (DE) 10 2025 129 227.2

(51) Int. Cl. G02C 7/02; C03C 3/064

(52) U.S. Cl. CPC G02C 7/022; C03C 3/064; G02C 2202/14

(57) ABSTRACT

An optical glass having a refractive index of more than 1.85, and glass articles comprising the optical glass, especially in the fields of optics and lenses, metaoptics and “augmented reality” (AR) are disclosed.

### CROSS REFERENCE TO RELATED APPLICATIONS

This application claims the benefit of priority from German Patent Application No. 10 2024 125 122.0, filed Sep. 3, 2024, and No. 10 2025 129 227.2, filed Jul. 24, 2025, the disclosures of each of which are incorporated herein by reference.

### FIELD OF THE INVENTION

The invention relates to an optical glass having a refractive index of more than 1.85, to glass articles comprising the optical glass and to the use thereof, especially in the fields of optics and lenses, metaoptics and “augmented reality” (AR).

### BACKGROUND OF THE INVENTION

The invention is concerned with glasses that can be used in the field of augmented reality (AR). For AR eyeglasses, high-refraction glasses—i.e. glasses having a high refractive index—are advantageous since they increase the field of view (FoV). On the other hand, the density of such glasses often rises to a greater-than-proportional degree with rising refractive index. This means that, even if it were possible to make wafers thinner for the AR application, the spectacle glass would become much heavier, which would make prolonged wearing of AR eyeglasses uncomfortable. Given the trend for headsets to become more like standard spectacles in shape, which are then to be worn for longer or—like normal spectacles—at all times, there is a need for the eyeglasses to become lighter. Such a reduction in weight is an advantage for other fields of use too, since camera optics in the digital single-lens reflex (DSLR) sector are also very often either very bulky or very heavy, which also significantly increases the battery power requirement of the autofocus.

Some of the glasses in the prior art derive from the niobium phosphate system or titanium phosphate system; they therefore comprise considerable proportions of P₂O₅ and niobium or titanium. Some of these glasses are very problematic in their production, since loss of oxygen, for example due to excessively high melting and refining temperatures in a phosphate system that is in any case already reducing, can result in lower oxidation states. In the case of niobium, this is for example an oxidation state of less than V and, in the case of titanium, of less than IV. This can result in an intense brown or even black colour in the niobium system or in a blue or yellow-green to brown colour, extending as far as black colouring, in the titanium system. In addition, the titanium increases the tendency to crystallization significantly, which in the heavy flint sector is a known problem of the existing high-refractive-index glasses, which are then for example no longer recompressible. Unlike niobium, even the highest oxidation state of titanium absorbs at the edge of the visible range, which at higher contents gives rise to the known yellow tinge of barium-titanium silicates.

Furthermore, the niobium phosphate family of glasses—like the high-refraction heavy flint or lanthanum heavy flint family—has a tendency not just to interfacial crystallization, but also shows very rapid crystal growth, which makes post-cooling (tension cooling or setting the refractive index) critical for optionally preseeded glasses. The glass is moreover known to be relatively brittle and therefore difficult to polish into very thin wafers.

On the other hand, climatic resistance at least for the niobium phosphate glasses is relatively good in spite of P₂O₅, and the density is very low for this high refractive index, which increases wearer comfort. These families are known from the literature.

The lanthanum heavy flint systems available on the market, which are within a refractive index range of interest for AR applications, have a much less favourable combination of refractive index n_{d} and density. The comparatively high density and relatively high Abbe number of these glasses is caused in particular by high lanthanum oxide contents. Moreover, such glasses have relatively high hardness, which increases the costs of wafer production as a result of the long grinding times. In some cases, raw glass costs are additionally also already much higher; in the production of these, raw materials from the rare earth sector, tungsten oxide, tantalum oxide and other costly raw materials are used. In the heavy flints sector, Nb₂O₅ is often the batch cost driver, while the other raw materials, even in optical quality, are relatively inexpensive by comparison. Moreover, the obtainable lanthanum heavy flint glasses are usually free of alkali metal oxides and hence not chemically curable. However, depending on the field of use, it may be advantageous to increase the mechanical stability of potentially ever thinner optical components (e.g. spectacle lenses) for AR applications by chemical curing.

Many heavy flint glasses, for example P-SF glasses, in this area of the Abbe diagram are firstly problematic owing to their batch costs and, owing to their high Bi₂O₃ contents, are additionally very soft (=scratch-sensitive) and have a disadvantageous UV transmission edge, for example an insufficiently steep UV edge and/or a UV edge that has been shifted into the longer-wave region of the spectrum. The P-SF glasses in particular are additionally produced discontinuously in a platinum crucible and, in a tank, can lead to problems with platinum alloying and reduction of Bi(III) down to Bi(0).

As mentioned above, there are some glasses that are more or less appropriate and are usually in the range of excessively low refraction values (typical heavy flint glasses) or are difficult to process or work (typical lanthanum heavy flint glasses).

Also known from the prior art are Pb-free heavy flint glasses containing a comparatively high proportion of Nb₂O₅. Nb₂O₅ makes a crucial contribution to a high refraction value of these glasses, but has a comparatively high density and high raw material costs.

### OBJECT AND SUMMARY OF THE INVENTION

It is an object of this invention to provide glasses that have a high refractive index n_{d} and at the same time minimum density. The glass should have as high as possible an internal transmittance and have good hot formability and good processibility. For this purpose, the hardness must not be too low (more scratches and microcracks), but not too high either (long grinding times and hence likewise microcracks). Glasses should have high chemical resistances and be producible economically.

In one aspect, this object is achieved by an optical glass having a refractive index n_{d} of more than 1.85, an Abbe number v_{d} of less than 35 and a temperature Tₘₐₓ of not more than 1350° C., comprising at least SiO₂ and TiO₂, comprising less than 30.0 mol % of SiO₂, less than 2.0 mol % of Nb₂O₅, less than 17 mol % of BaO and less than 5.0 mol % of Ln₂O₃, where Ln₂O₃═Y₂O₃, La₂O₃, Gd₂O₃ and/or Yb₂O₃.

In the context of the invention, a TiO₂- and SiO₂-containing glass system has been found that, by comparison with the glasses composed of the niobium phosphate or titanium phosphate system described at the outset, is more stable in respect of achievable internal transmission and has a higher refractive index and yet a relatively low density. Moreover, the glass system has higher hardness and lower batch costs than the niobium phosphate glasses described.

The optical glass of the invention has a refractive index n_{d} of more than 1.85 and preferably not more than 2.05.

In advantageous embodiments, the refractive index n_{d} is at least 1.87, preferably at least 1.88, preferably at least 1.89, preferably at least 1.90, preferably more than 1.90, preferably at least 1.92 or at least 1.93, preferably at least 1.95, preferably at least 1.960, preferably at least 1.965, preferably at least 1.970, preferably at least 1.975, preferably at least 1.980 and preferably at least 1.985. An advantageous upper n_{d} limit may be 2.05 or 2.050 or 2.045 or 2.040 or 2.035 or 2.030 or 2.025 or 2.020. Overall, the refractive index is thus advantageously within a range from more than 1.85 to 2.05. The refractive index n_{d} is known to those skilled in the art and refers in particular to the refractive index at a wavelength of about 587.6 nm (wavelength of the d line of helium). Those skilled in the art will know how the refractive index n_{d} can be determined.

Preferably, the refractive index is determined with a refractometer, in particular with a V-block refractometer. In this case, samples having a square or approximately square base area (for example having dimensions of about 20 mm×20 mm×5 mm) may in particular be used. In the measurement with a V-block refractometer, the samples are generally placed in a V-shaped block prism having a known refractive index. The refraction of an incident light beam depends on the difference between the refractive index of the sample and the refractive index of the V-block prism, thereby allowing the refractive index of the sample to be determined. The measurement is preferably carried out at a temperature of 22° C.

According to the invention, the glass has an Abbe number, i.e. dispersion (v_{d}), of less than 35. In advantageous embodiments, the dispersion is less than 32, preferably less than 30 or less than 25, preferably less than 24 or less than 23 or less than 22, and/or more than 18, preferably more than 18.5, further preferably more than 19.0. Dispersion v_{d} is calculated in a known manner by determining the refractive indices n_{d} (at about 587.6 nm), n_{F} (at about 486 nm) and n_{C} (at about 656 nm) with a refractometer and expressing them in relation to one another:

$${v}_{d} = ( {n}_{d} - 1 ) / ( {n}_{F} - {n}_{C} ) .$$

In addition, the glass of the invention has a temperature Tₘₐₓ of ≤1350° C. Tₘₐₓ is a composition-dependent glass variable and indicates the temperature that is at least necessary in the melting process in order to generate a “blank” melt from the starting materials (for example raw materials, shards, etc.). A “blank” melt exists here when there are no remnants from melting—for example incompletely melted raw materials—and no crystals present in the melt. As explained in the introduction, the melting and refining temperatures should be as low as possible in order to avoid ingress of refractory material into the glass and colouring of the glass by polyvalent ions in a low oxidation state. This allows high internal transmission to be achieved. The requirement to achieve the highest-possible internal transmission means that the chosen melting and refining temperatures cannot be too high, consequently the melting temperature has an upper limit, hence the use also of the term “Tₘₐₓ” for the temperature described here. Tₘₐₓ is thus the lowest temperature at which a blank, crystal-free melt can still be produced. This relationship makes Tₘₐₓ a good measure for the liquidus temperature of the glass (see below).

In the context of the invention, the Tₘₐₓ of a glass composition is determined systematically on a laboratory scale in test series by melting the same glass from the starting components in small crucibles having a volume of in each case 20 ml at different maximum temperatures, with temperature increments of 10° C. chosen. Starting with the lowest temperature up to the highest temperature, the melting result is then visually evaluated in respect of whether a blank melt has been obtained or whether there are still remnants and/or crystals present in the glass.

The Tₘₐₓ value determined for a composition in this way is reproducible even with laboratory melts of larger volume (e.g. 1 litre). Moreover, further experiments have shown that the temperature Tₘₐₓ is only slightly above the liquidus temperature of the glass. It was inferred that the temperature Tₘₐₓ, which can be determined in an easily operated laboratory procedure, is a good measure for the liquidus temperature of the glass, which is not determined exactly here.

In an advantageous development of the invention, Tₘₐₓ is not more than 1330° C., advantageously not more than 1320° C., preferably not more than 1310° C., more preferably not more than 1300° C. Some advantageous variants have a Tₘₐₓ of not more than 1290° C. or not more than 1280° C.

In one advantageous embodiment, the glass has a glass transition temperature T_{g} of 500° C. to 800° C. Preferably, T_{g} may be more than 540° C., advantageously more than 560° C., preferably more than 580° C., and/or not more than 750° C., not more than 700° C. or not more than 650° C. A higher T_{g} can be advantageous in respect of stability to crystallization, since this means that the difference in temperature from Tₘₐₓ is lower and the glass achieves a stable glassy state more rapidly. The glasses can however still readily undergo heat-forming and processing.

In an advantageous embodiment, the glass according to the invention has a molar ratio of (TiO₂+ZrO₂+2*Nb₂O₅+2*Ta₂O₅+2*Al₂O₃+SiO₂+B₂O₃)/(R₂O+RO+2*Ln₂O₃) of 1.5-3.5, where R₂O═Li₂O, Na₂O and/or K₂O and RO═MgO, CaO, SrO and/or BaO and Ln₂O₃═Y₂O₃, La₂O₃, Gd₂O₃ and/or Yb₂O₃. In relation to the ratio of the proportions of the TiO₂, ZrO₂, Nb₂O₅, Ta₂O₅, Al₂O₃, SiO₂ and B₂O₃ components to the proportions of the R₂O, RO and Ln₂O₃ components, it should be noted that the proportions should be chosen so as to meet the inventive condition (TiO₂+ZrO₂+2*Nb₂O₅+2*Ta₂O₅+2*Al₂O₃+SiO₂+B₂O₃)/(R₂O+RO+2*Ln₂O₃)=1.5-3.5. In the case of higher ratios, there is the risk of unwanted crystallization and/or unwanted discoloration of the glasses. There is also the risk of unwanted crystallization when the ratio is too low. The glass according to the invention preferably has a molar ratio of (TiO₂+ZrO₂+2*Nb₂O₅+2*Ta₂O₅+2*Al₂O₃+SiO₂+B₂O₃)/(R₂O+RO+2*Ln₂O₃) of 1.8 to 3.2, more preferably of 2.0 to 3.0 and especially preferably of 2.1 to 2.9.

In an advantageous embodiment, the glass according to the invention has a molar ratio of (TiO₂+ZrO₂+2*Nb₂O₅+2*Ta₂O₅+2*Al₂O₃+SiO₂+B₂O₃)/(R₂O+CS₂O+RO+2*Ln₂O₃) of 1.5-3.5, where R₂O═Li₂O, Na₂O and/or K₂O and RO═MgO, CaO, SrO and/or BaO and Ln₂O₃═Y₂O₃, La₂O₃, Gd₂O₃ and/or Yb₂O₃. In relation to the ratio of the proportions of the TiO₂, ZrO₂, Nb₂O₅, Ta₂O₅, Al₂O₃, SiO₂ and B₂O₃ components to the proportions of the R₂O, Cs₂O, RO and Ln₂O₃ components, it should be noted that the proportions should be chosen so as to meet the inventive condition (TiO₂+ZrO₂+2*Nb₂O₅+2*Ta₂O₅+2*Al₂O₃+SiO₂+B₂O₃)/(R₂O+Cs₂O+RO+2*Ln₂O₃)=1.5-3.5. In the case of higher ratios, there is the risk of unwanted crystallization and/or unwanted discoloration of the glasses. There is also the risk of unwanted crystallization when the ratio is too low. The glass according to the invention preferably has a molar ratio of (TiO₂+ZrO₂+2*Nb₂O₅+2*Ta₂O₅+2*Al₂O₃+SiO₂+B₂O₃)/(R₂O+CS₂O+RO+2*Ln₂O₃) of 1.8 to 3.2, more preferably of 2.0 to 3.0 and especially preferably of 2.1 to 2.9.

Preferably, the optical glass according to the invention has a density p of not more than 4.5 g/cm³, preferably not more than 4.3 g/cm³, preferably not more than 4.1 g/cm³, more preferably not more than 4.0 g/cm³, especially preferably not more than 3.90 g/cm³ and more especially preferably not more than 3.85 g/cm³ or not more than 3.8 g/cm³. Preferably, the density of the glass according to the invention is from 3.0 g/cm³ to 4.5 g/cm³, preferably from 3.2 g/cm³ to 4.3 g/cm³, preferably from 3.5 g/cm³ to 4.1 g/cm³, more preferably from 3.6 g/cm³ to 4.0 g/cm³ or from 3.6 g/cm³ to 3.85 g/cm³ or from 3.6 g/cm³ to 3.8 g/cm³.

Preferably, the glass has a ratio of density ρ to refractive index n_{d} (ρ/n_{d}) of not more than not more than 2.0, preferably not more than 1.95 g/cm³. In some advantageous embodiments, the glass has a ratio of density ρ to refractive index n_{d} (ρ/n_{d}) of not more than 1.90 g/cm³, preferably not more than 1.89 g/cm³ or not more than 1.88 g/cm³. In some advantageous embodiments, the glass has a ratio of density ρ to refractive index n_{d} (ρ/n_{d}) of not more than 1.87 g/cm³, preferably not more than 1.86 g/cm³.

Preferably, the optical glass according to the invention has a ratio of Abbe number v_{d} to density ρ (v_{d}/ρ) of 4.5 cm³/g to 7.5 cm³/g, preferably of 4.8 cm³/g to 7.0 cm³/g or preferably of 4.9 cm³/g to 6.5 cm³/g, more preferably of 5.0 cm³/g to 6.0 cm³/g.

Preferably, the glass has a product of Abbe number v_{d} and density ρ of less than 100 g/cm³, preferably less than 95 g/cm³, preferably less than 90 g/cm³, more preferably less than 80 g/cm³, and preferably more than 50 g/cm³, preferably more than 55 g/cm³, preferably more than 60 g/cm³, preferably more than 65 g/cm³, especially preferably more than 70 g/cm³.

According to the invention, the glass has an SiO₂ content of less than 30.0 mol %. SiO₂ is a glass former. The oxide contributes greatly to chemical resistance, but also increases processing temperatures. If it is used in very large amounts, the refractive index values of the invention cannot be achieved. Preferably, the glass contains at least 10.0 mol %, preferably at least 12.0 mol %, preferably at least 13.0 mol %, more preferably at least 15.0 mol %, of SiO₂. The glass includes less than 30.0 mol %, preferably not more than 28.0 mol %, preferably not more than 25.0 mol %, especially preferably not more than 23.0 mol %, of SiO₂. In advantageous embodiments, the glass contains from 10.0 mol % to <30.0 mol %, preferably 12.0 mol % to 28.0 mol %, preferably from 13.0 mol % to 25.0 mol %, further preferably from 15.0 mol % to 23.0 mol %, of SiO₂.

B₂O₃ likewise acts as a glass former. In the glass system of the invention, it can contribute to lowering the temperature Tₘₐₓ. Preferably, the glass contains 0 mol % to 8.0 mol %, preferably from 0 mol % to 5.0 mol % or from 1.0 mol % to 5.0 mol % of B₂O₃. Some advantageous variants may contain at least 1.0 mol % or at least 1.5 mol % or at least 2.0 mol % of B₂O₃. Preferably, the B₂O₃ content is limited to not more than 7.0 mol %, preferably not more than 6.5 mol %, preferably not more than 5.0 mol %, more preferably not more than 4.0 mol %, preferably not more than 3.0 mol %. Some advantageous variants contain not more than 0.5 mol %, preferably less than 0.1 mol %, of B₂O₃. Some advantageous variants are free of B₂O₃.

It is advantageous not to choose too small a total amount of glass formers on the one hand, since they stabilize the glass, and on the other hand to limit the content in order to obtain a glass with high refractive index. Preferably, the glass of this invention therefore has a total content of SiO₂ and B₂O₃ of 12.0 mol % to 28.0 mol %, preferably of 12.0 mol % to 25.0 mol %, preferably of 15.0 mol % to 23.0 mol %.

The glass of the invention may contain Nb₂O₅, but the use of Nb₂O₅ may lead to elevated batch costs and a higher density of the glass. Therefore, the content of Nb₂O₅, according to the invention, is limited to less than 2.0 mol %, preferably less than 1.5 mol %, further preferably less than 1.0 mol % and especially preferably less than 0.5 mol % of Nb₂O₅. Preferred embodiments of the glass of the invention are essentially free of Nb₂O₅.

Preferably, the glass contains at least 35.0 mol %, preferably at least 37.0 mol %, preferably at least 40.0 mol % or preferably at least 43.0 mol %, and/or not more than 65.0 mol %, preferably not more than 61.0 mol % or not more than 60.0 mol %, further preferably not more than 55.0 mol %, of TiO₂. In some advantageous embodiments, the glass contains 35.0 mol % to 65.0 mol %, preferably from 40.0 mol % to 60.0 mol %, further preferably from 43.0 mol % to 55.0 mol %, of TiO₂.

In addition to TiO₂, the glass preferably also comprises BaO, where the glass preferably has a total content of BaO and TiO₂ of at least 35.0 mol %, preferably of at least 40.0 mol % or of at least 42.0 mol %, or of at least 45.0 mol %, further preferably of at least 50.0 mol %, and/or not more than 70.0 mol %, preferably not more than 65.0 mol %, preferably not more than 63.0 mol % or not more than 60.0 mol %.

The glass may optionally contain Al₂O₃. Al₂O₃ can contribute to chemical resistance of the glass. The glass may contain from 0 to 8.0 mol % or from 0 to 5.0 mol % or up to 3.0 mol %, or up to 2.0 mol % or up to 1.0 mol %, of Al₂O₃. Some advantageous embodiments contain less than 0.5 mol % of Al₂O₃. Preferred variants are free of Al₂O₃. Some advantageous variants may contain 0.5 mol % to 3.0 mol %, preferably 0.75 mol % to 2.5 mol %, or from 2.0 mol % to 5.0 mol %.

The glass may contain ZrO₂. ZrO₂ contributes to attainment of the high refractive index, but also increases the tendency of the glass to crystallization, and so the content thereof is preferably limited to not more than 7.5 mol %, preferably not more than 6.5 mol %, likewise preferably not more than 5.5 mol % or not more than 5.0 mol %. In some advantageous embodiments, the glass contains at least 0.5 mol %, preferably at least 1.5 mol %, preferably at least 2.5 mol % to 3.0 mol %, of ZrO₂. In some embodiments, the glass contains 0.5 mol % to 7.5 mol %, preferably 1.5 mol % to 6.5 mol %, further preferably 2.5 mol % to 5.5 mol % and especially preferably 3.0 mol % to 5.0 mol % of ZrO₂. Some embodiments may be free of ZrO₂.

The glass preferably contains Li₂O, Na₂O and/or K₂O. The glass preferably has a total R₂O content, where R₂O═Li₂O, Na₂O and/or K₂O, of at least 1.0 mol %, further preferably at least 2.0 mol %, especially preferably at least 3.0 mol % or at least 4.0 mol %, and/or not more than 20.0 mol %, preferably not more than 17.0 mol %, further preferably not more than 15 mol % and especially preferably not more than 14 mol %. Preferably, the glass has a total of R₂O content of 1.0 mol % to 20 mol %, preferably from 2.0 mol % to 17.0 mol %, further preferably from 3.0 mol % to 15.0 mol %, and likewise preferably from 4.0 mol % to 14 mol %. The alkali metal oxides mentioned contribute to good processibility, but excessively high contents can reduce chemical resistance and lower the refractive index too greatly. Some embodiments may be free of R₂O.

In some advantageous embodiments, the glass comprises one of Li₂O, Na₂O and K₂O. In some advantageous embodiments, the glass comprises at least two of Li₂O, Na₂O and K₂O. In some advantageous embodiments, the glass comprises Na₂O and at least one of Li₂O and K₂O. In some embodiments, the glass comprises Li₂O, Na₂O and K₂O.

In some embodiments, the glass contains Li₂O. Since Li₂O can attack the material of crucibles and tanks, the content thereof is preferably limited. The content of Li₂O is preferably in the range from 0 mol % to 10.0 mol %, preferably from 0.5 mol % to 7.0 mol %, further preferably from 1.0 mol % to 5.0 mol % or from 1.5 mol % to 3.0 mol % or to 2.0 mol %. In some advantageous embodiments, the glass is free of Li₂O.

In advantageous embodiments, the glass contains Na₂O. The content of Na₂O is preferably in the range from 0.5 mol % to 18.0 mol %, or from 0.5 mol % to 15.0 mol %, preferably from 1.0 mol % to 13.5 mol % or to 12.5 mol %. In some advantageous embodiments, the glass contains at least 1.0 mol %, preferably at least 1.5 mol %, preferably at least 2.0 mol %, at least 3.0 mol %, and/or not more than 18.0 mol % or not more than 15.0 mol %, preferably not more than 13.5 mol % or not more than 12.5 mol %, preferably not more than 11.0 mol %, of Na₂O. In some advantageous embodiments, the glass may be free of Na₂O.

In some advantageous embodiments, the glass contains K₂O, where the K₂O content is less than 5.0 mol %, preferably less than 3.0 mol %, preferably in the range of more than 0 mol % to 5.0 mol %, preferably of 0.5 mol % to 3.0 mol %. In some advantageous embodiments, the glass is free of K₂O.

In advantageous embodiments, the glass contains at least one alkaline earth metal oxide RO, where RO is selected from MgO, CaO, SrO and/or BaO. The glass preferably contains at least BaO. The glass preferably contains BaO and at least one of MgO, CaO and SrO. CaO and SrO lower the melting temperature and stabilize the glass against crystallization without reducing its chemical resistance to the same degree as alkali metal oxides.

Preferably, the total content of MgO, CaO and SrO is in the range of 2.0 mol % to 25.0 mol %. In some advantageous variants, the glass contains a total content of MgO, CaO and SrO in the range of 5.0 mol % to 22.0 mol %. In some advantageous embodiments, the total content of MgO, CaO and SrO is in the range of 5.0 to 10.0 mol %. In some advantageous embodiments, the total content of MgO, CaO and SrO is in the range of 12.0 mol % to 22.0 mol %.

In some advantageous embodiments, the glass contains BaO and at least one of MgO, CaO and SrO, preferably MgO and/or CaO. The glass preferably has a total RO content, where RO═MgO, CaO, SrO and/or BaO, of 5.0 mol % to 25.0 mol %, preferably of 8.0 mol % to 31.0 mol %, preferably from 10.0 mol % to 28.0 mol %, preferably from 12.0 mol % to 24.0 mol %.

The glass preferably contains BaO. Advantageously, the glass contains more than 0 mol % to 17.0 mol %, more than 0 mol % to 15.0 mol %, preferably from 1.0 mol % to 12 mol % or to 13.0 mol %, further preferably from 2.0 mol % to 11.0 mol % or to 13.0 mol %, of BaO.

In some advantageous embodiments, the glass contains MgO with a content of more than 0 mol % to 10.0 mol %, preferably of 0.5 mol % to 7.5 mol % or of 1.0 mol % to 6.0 mol %. Some advantageous variants contain from more than 0 mol % to 3.0 mol %, preferably 1.0 mol % to 3.0 mol %, of MgO. Some advantageous variants are free of MgO.

In advantageous embodiments, the glass contains CaO. The CaO content is preferably in the range from more than 0 mol % to 30.0 mol %, preferably from 1.0 mol % to 25.0 mol %. In some advantageous embodiments, the glass contains from 2.0 mol % to 22.0 mol %, preferably from 3.0 mol % to 19.0 mol % and likewise preferably from 5.0 mol % to 15.0 mol % of CaO. Some embodiments may be free of CaO.

The content of SrO is preferably in the range from 0 mol % to 5.0 mol % or 4.0 mol %. In some advantageous embodiments, the content of SrO is in the range from 0 mol % or 1.0 mol % to 3.0 mol %, preferably from 1.5 mol % to 2.5 mol %. Some advantageous embodiments are free of SrO.

The glass preferably contains a total content of RO+R₂O in the range from 15.0 mol % to 40.0 mol %, preferably 20.0 mol % to 35.0 mol %, preferably from 23.0 mol % to 31.0 mol %. Glasses that have the total content of RO and R₂O mentioned show favourable glass formation properties. If the content of RO and R₂O is too low, the glasses have an unfavourably high melting temperature; if the contents are too high, there is a rise in the tendency of the glasses to crystallization.

The glass may optionally contain ZnO. However, ZnO is detrimental to water quality and can attack tanks and crucibles; therefore, the ZnO content is preferably limited to less than 10.0 mol %. In advantageous embodiments, the glass has a ZnO content of not more than 7.5 mol %, or not more than 5.5 mol %, further preferably not more than 3.5 mol %. In some advantageous embodiments, the glass has a ZnO content of 0.5 mol % to 7.5 mol %, preferably of 0.5 mol % to 5.5 mol % and further preferably of 0.75 mol % to 3.5 mol %. Some advantageous variants are free of ZnO.

Optionally, the glass may contain Ln₂O₃, where Ln₂O₃═La₂O₃, Gd₂O₃, Y₂O₃ and/or Yb₂O₃. In general, these components may be used in order to increase the refraction value of the glasses, but Ln₂O₃-containing glasses typically have a higher density. Therefore, the content of Ln₂O₃ is limited to less than 5.0 mol %, preferably less than 2.0 mol %, preferably less than 1.0 mol %, especially preferably less than 0.5 mol %. The glass is preferably free of Ln₂O₃.

Addition of conventional refining agents is unnecessary, since the melt has low toughness at the temperatures necessary for melting. When refining agents such as As₂O₃, Sb₂O₃, SO₃, F and/or CI are nevertheless added, the content thereof can be significantly lowered, for example to <0.1 mol %. Pure physical refinement is also possible and advantageous. The glass may optionally include one or more of the following components having a refining effect in the stated proportions in mol %:

| | |
|---|---|
| Sb₂O₃ | 0.0 to 1.0 |
| As₂O₃ | 0.0 to 1.0 |
| SO₃ | 0.0 to 1.0 |
| F | 0.0 to 1.0 |
| Cl | 0.0 to 1.0 |

Sulfate (SO₃) may be present in a small proportion in the glass in order to stabilize higher oxidation states in polyvalent ions. When it is present, the proportion is at least 0.01 mol %. Higher proportions of sulfate increase the risk of pronounced bubble formation in the glass and the risk of platinum getting into the glass. The sulfate content may therefore advantageously be max. 0.5 mol %, preferably max. 0.1 mol %, preferably max. 0.05 mol %. Preferably, the glass is SO₃-free.

F may have a positive effect in some embodiments on the transmittance of the glass in that it stabilizes higher oxidation states in the case of polyvalent ions.

The glass may contain small amounts of hafnium (HfO₂), preferably not more than 0.2 mol %, more preferably not more than 0.1 mol % or not more than 0.05 mol %. In general, rather than being actively added, it gets into the glass with the ZrO₂ component via the raw material. When a very pure ZrO₂ raw material is used, the glass is advantageously HfO₂-free.

In an advantageous embodiment, the glass includes the following components in mol %:

| | | |
|---|---|---|
| SiO₂ | 10.0-<30.0 | preferably 12.0-28.0 |
| B₂O₃ | 0-8.0 | preferably 0-5.0 |
| TiO₂ + BaO | 35.0-70.0 | preferably 40.0-65.0 |
| R₂O + RO | 15.0-40.0 | preferably 20.0-35.0 |
| ZnO | <10.0 | preferably ≤7.5 |
| Ln₂O₃ | <2.0 | preferably <1.0 |

In an advantageous embodiment, the glass includes the following components in mol %:

| | | |
|---|---|---|
| SiO₂ | 10.0-<30.0 | preferably 12.0-28.0 |
| B₂O₃ | 0-8.0 | preferably 0-5.0 |
| TiO₂ + BaO | 35.0-70.0 | preferably 40.0-65.0 |
| R₂O | 1.0-20.0 | preferably 2.0-17.0 |
| RO | 8.0-31.0 | preferably 10.0-28.0 |
| R₂O + RO | 15.0-40.0 | preferably 20.0-35.0 |
| ZnO | ≤7.5 | preferably ≤5.5 |
| ZrO2 | 0.5-7.5 | preferably 1.5-6.5 |
| Ln₂O₃ | <1.0 | preferably 0 |

In an advantageous embodiment, the glass includes the following components in mol %:

| | | |
|---|---|---|
| SiO₂ | 12.0-28.0 | preferably 13.0-25.0 |
| B₂O₃ | 0-5.0 | preferably 0-4.0 |
| TiO₂ + BaO | 40.0-65.0 | preferably 45.0-63.0 |
| TiO₂ | 35.0-65.0 | preferably 40.0-61.0 |
| R₂O | 2.0-17.0 | preferably 3.0-15.0 |
| Li₂O | 0-10.0 | preferably 0-7.0 |
| Na₂O | 0.5-15.0 | preferably 1.0-13.5 |
| K₂O | 0-5.0 | preferably 0-3.0 |
| RO | 10.0-28.0 | preferably 12.0-24.0 |
| MgO | 0-10.0 | preferably 0-7.5 |
| CaO | 1.0-25.0 | preferably 2.0-22.0 |
| SrO | 0-5.0 | preferably 0-3.0 |
| BaO | 1.0-12.0 | preferably 2.0-11.0 |
| R₂O + RO | 20.0-35.0 | preferably 23.0-31.0 |
| ZnO | 0-5.5 | preferably 0-3.5 |
| ZrO2 | 1.5-6.5 | preferably 2.5-5.5 |
| Ln₂O₃ | <1.0 | preferably 0 |

In an advantageous embodiment, the glass includes the following components in mol %:

| | |
|---|---|
| SiO₂ | 15.0-<30.0 |
| B₂O₃ | 0-5.0 |
| TiO₂ + BaO | 40.0-65.0 |
| R₂O | 1.0-20.0 |
| RO | 8.0-28.0 |
| R₂O + RO | 20.0-35.0 |
| ZnO | ≤3.5 |
| ZrO2 | 0.5-7.5 |
| Ln₂O₃ | <1.0 |

In an advantageous embodiment, the glass includes the following components in mol %:

| | |
|---|---|
| SiO₂ | 10.0-20.0 |
| B₂O₃ | 0-5.0 |
| TiO₂ + BaO | 45.0-60.0 |
| R₂O | <1.0, preferably 0 |
| RO | 25.0-40.0 |
| R₂O + RO | 25.0-40.0 |
| ZnO | ≤3.5, preferably ≤2.5 |
| ZrO2 | 2.5-7.5 |
| Ln₂O₃ | <1.0 |

In an advantageous embodiment, the glass consists to an extent of at least 95.0 mol %, especially to an extent of at least 98.0 mol % or to an extent of at least 99.0 mol %, of the components described herein, especially of the components listed in the tables above. In one embodiment, the glass essentially consists entirely of these components.

Preferably, the glass is essentially free of bismuth (Bi₂O₃) and/or lead (PbO). The addition of bismuth would increase the density of the glass disproportionately. Moreover, bismuth ions undergo reduction to elemental bismuth even at relatively low temperatures in the region of 1000° C., imparting a strong grey colour to the glass. PbO is likewise avoided because of its adverse effect on a low density. It is also one of the toxic components.

The high contents of niobium and titanium mean that costly components such as tantalum (Ta₂O₅) and/or tungsten (WO₃) and/or germanium (GeO₂), for example, are needed in the glass only with a small proportion, if at all, in order to obtain a glass having the desired high refractive index.

The glass is preferably free of phosphate (P₂O₅) since it makes the melt much more reducing, and lowers transmittance via reduction of TiO₂ and/or Nb₂O₅. In addition, a reducing melt can corrode platinum, which increases the introduction of platinum into the melt and leads to discoloration or elevated scatter in the glass.

Optionally, the glass is—based on the respective cations-essentially free of one or more constituents selected from cadmium, gallium, germanium, thallium, colouring components—for example cobalt, vanadium, chromium, molybdenum, copper, nickel—and combinations thereof. Components such as iron, cerium, manganese, selenium and/or tellurium may be present in small proportions in the glass; for example, they may get into the glass as impurities. Particularly iron, cerium, selenium and tellurium, but also manganese, can act as redox partners. However, it is advantageous when these components too are not specifically added to the glass either individually or in combination.

When this description states that the glass is free of a component or does not contain a certain component, what this means is that said component may at most be present as an impurity in the glass. This means that it is not added in significant amounts. According to the invention, amounts that are not significant are amounts of less than 100 ppm, preferably less than 50 ppm and most preferably less than 10 ppm (m/m).

The optical glass preferably has an internal transmittance (τᵢ (10 mm, 460 nm)) of at least 80%, preferably at least 85%, more preferably at least 90% and especially preferably at least 93%, measured at a wavelength of 460 nm and a sample thickness of 10 mm.

Internal transmittance or the degree of internal transmittance can be measured by customary methods that are familiar to those skilled in the art, for example according to DIN 5036-1:1978. In this description, internal transmittance figures are based on a wavelength of 460 nm and a sample thickness of 10 mm. The statement of a “sample thickness” does not mean that the glass has that thickness, but merely states the thickness to which the internal transmittance figure relates.

Unless stated otherwise or obvious to those skilled in the art, measurements described herein are carried out at 20° C. and at an air pressure of 101.3 kPa.

In one aspect the invention relates to a glass article that includes or consists of the glass according to the invention. The glass article may take different forms. Optionally, the article has the form of
a glass substrate, especially as a constituent of a stack of substrates for an optical component, especially in a pair of AR eyeglasses,
a wafer, especially having a maximum diameter of 5.0 cm to 50.0 cm or having a diameter between 0.7 cm and 50 cm, preferably between 3 cm and 45 cm or between 5 cm and 40 cm,
a lens, especially a spherical lens, a rod lens, a prism or an asphere, and/or
an optical waveguide, especially a fibre or plate.

In a further aspect, the glass article according to the invention is a chemically hardened glass article, especially a chemically hardened glass substrate, a chemically hardened wafer and/or a chemically hardened lens. It will be apparent to the person skilled in the art that the glass article here is one comprising the optical glasses according to the invention that are chemically hardenable.

A glass that is chemically hardenable in the context of the present disclosure means a glass amenable to an ion exchange process. In such a process, in a surface layer of a glass article, for example of a wafer, ions of alkali metals are exchanged. This is effected in that a compressive stress zone is then formed in the surface layer, which is achieved by exchange of ions having smaller radii for ions having greater radii. For this purpose, the glass article is immersed into what is called an ion exchange bath, for example a salt melt, wherein the ion exchange bath comprises the ions having the greater ionic radii, especially sodium and/or potassium ions, such that these migrate into the surface layer of the glass article. In exchange for these, ions having smaller ionic radii, especially lithium and or sodium ions, migrate from the surface layer of the glass article into the ion exchange bath.

This forms a compressive stress zone. This can be described by the characterizing parameters of the compressive stress, “CS” for short, and the compressive stress depth, also referred to as “depth of layer” or “DoL” for short. This compressive stress depth DoL is sufficiently well known to the person skilled in the art and, in the context of the present disclosure, refers to that depth where the stress curve crosses the zero stress line.

Such chemically hardened glass articles can achieve higher mechanical strengths.

The production of the chemically hardened glass article preferably comprises the following steps:
a) providing the above-described glass article,
b) performing at least one first ion exchange, and
c) optionally performing a second ion exchange.

The first ion exchange is preferably effected for a period of 0.5 to 24 hours, preferably of 1 to 5 hours, more preferably of 2 to 8 hours, at a temperature of 350° C. to 500° C., preferably of 370° C. to 450° C., more preferably of 380° C. to 430° C., where the exchange bath contains at least one potassium salt, especially KNO₃, and/or at least one sodium salt, especially NaNO₃.

In some advantageous embodiments, there is subsequently a second ion exchange for a period of 0.5 to 24 hours, preferably of 1 to 5 hours, more preferably of 2 to 8 hours, at a temperature of 350° C. to 500° C., preferably of 370° C. to 450° C., more preferably of 380° C. to 430° C., where the exchange bath contains at least one potassium salt, especially KNO₃, and/or at least one sodium salt, especially NaNO₃.

In a further aspect the invention relates to the use of a glass or glass article described herein in AR eyeglasses, metaoptics, wafer-level optics, optical wafer applications or classical optics. Alternatively or in addition, the glass or glass article described herein may be used as a wafer, lens or optical waveguide.

The glasses of the invention may be produced by melting commercial raw materials. For example, it is possible to melt the glasses in a device as described in DE 10 2020 120168 A1.

### EXAMPLES

The compositions shown in Tables 1 to 4 below were melted and their properties were examined.

### Compositions and Properties:

TABLE 1

| mol % | 1 | 2 | 3 | 4 | 5 | 6 | 7 |
|---|---|---|---|---|---|---|---|
| B₂O₃ | 2.90 | 2.90 | 0.00 | 2.90 | 1.00 | 0.00 | 0.00 |
| BaO | 9.37 | 7.03 | 7.82 | 8.49 | 0.00 | 7.82 | 7.38 |
| TiO₂ | 47.67 | 47.67 | 50.92 | 47.49 | 47.87 | 50.92 | 50.83 |
| Nb₂O₅ | 0.00 | 0.00 | 0.00 | 0.00 | 0.00 | 0.00 | 0.00 |
| SiO₂ | 17.40 | 17.40 | 17.88 | 17.41 | 18.04 | 17.88 | 17.88 |
| Al₂O₃ | 0.00 | 0.00 | 0.00 | 0.00 | 0.00 | 0.00 | 0.00 |
| MgO | 0.00 | 0.00 | 0.00 | 0.00 | 4.20 | 0.00 | 0.00 |
| CaO | 14.05 | 16.39 | 7.82 | 14.15 | 15.92 | 7.82 | 7.38 |
| Li₂O | 0.00 | 0.00 | 1.17 | 0.00 | 0.00 | 0.00 | 0.00 |
| Na₂O | 3.51 | 4.52 | 8.21 | 4.55 | 6.63 | 10.56 | 10.59 |
| K₂O | 1.51 | 0.50 | 2.35 | 0.51 | 0.74 | 1.17 | 1.18 |
| ZnO | 0.00 | 0.00 | 0.00 | 0.94 | 0.88 | 0.00 | 0.94 |
| SrO | 0.00 | 0.00 | 0.00 | 0.00 | 1.11 | 0.00 | 0.00 |
| As₂O₃ | 0.00 | 0.00 | 0.00 | 0.00 | 0.00 | 0.00 | 0.00 |
| Y₂O₃ | 0.00 | 0.00 | 0.00 | 0.00 | 0.00 | 0.00 | 0.00 |
| Sb₂O₃ | 0.00 | 0.00 | 0.00 | 0.00 | 0.00 | 0.00 | 0.00 |
| La₂O₃ | 0.00 | 0.00 | 0.00 | 0.00 | 0.00 | 0.00 | 0.00 |
| Gd₂O₃ | 0.00 | 0.00 | 0.00 | 0.00 | 0.00 | 0.00 | 0.00 |
| ZrO₂ | 3.59 | 3.59 | 3.83 | 3.57 | 3.60 | 3.83 | 3.83 |
| Total | 100.00 | 100.00 | 100.00 | 100.00 | 100.00 | 100.00 | 100.00 |

Properties

| | | | | | | | |
|---|---|---|---|---|---|---|---|
| n_{d} | 1.994 | 1.993 | 1.989 | 1.994 | 1.988 | 1.988 | 1.989 |
| v_{d} | 20.5 | 20.8 | 20.1 | 20.6 | 20.6 | 20.2 | 20.1 |
| Density [g/cm³] | 3.73 | 3.67 | 3.65 | 3.73 | 3.47 | 3.66 | 3.65 |

TABLE 2

| mol % | 8 | 9 | 10 | 11 | 12 | 13 | 14 |
|---|---|---|---|---|---|---|---|
| B₂O₃ | 0.00 | 0.94 | 1.05 | 1.04 | 0.00 | 0.00 | 0.00 |
| BaO | 7.38 | 7.42 | 8.46 | 8.46 | 8.47 | 7.38 | 8.36 |
| TiO₂ | 50.28 | 50.76 | 48.25 | 48.45 | 50.28 | 50.28 | 48.97 |
| Nb₂O₅ | 0.00 | 0.00 | 0.00 | 0.00 | 0.00 | 0.00 | 0.00 |
| SiO₂ | 17.88 | 16.85 | 18.87 | 18.68 | 17.88 | 17.88 | 18.91 |
| Al₂O₃ | 0.00 | 0.00 | 0.00 | 0.00 | 0.00 | 0.00 | 0.00 |
| MgO | 0.00 | 0.00 | 0.00 | 0.00 | 0.00 | 0.00 | 0.00 |
| CaO | 7.38 | 7.42 | 11.84 | 11.84 | 6.28 | 6.28 | 9.29 |
| Li₂O | 0.00 | 0.00 | 0.00 | 0.00 | 0.00 | 0.00 | 0.00 |
| Na₂O | 10.59 | 10.66 | 7.05 | 6.48 | 10.59 | 10.59 | 8.45 |
| K₂O | 1.18 | 1.18 | 0.00 | 0.56 | 1.18 | 1.18 | 0.84 |
| ZnO | 0.94 | 0.95 | 0.85 | 0.85 | 0.94 | 0.94 | 0.93 |
| SrO | 0.00 | 0.00 | 0.00 | 0.00 | 0.00 | 1.10 | 0.00 |
| As₂O₃ | 0.00 | 0.00 | 0.00 | 0.00 | 0.00 | 0.00 | 0.00 |
| Y₂O₃ | 0.00 | 0.00 | 0.00 | 0.00 | 0.00 | 0.00 | 0.00 |
| Sb₂O₃ | 0.00 | 0.00 | 0.00 | 0.00 | 0.00 | 0.00 | 0.00 |
| La₂O₃ | 0.00 | 0.00 | 0.00 | 0.00 | 0.00 | 0.00 | 0.00 |
| Gd₂O₃ | 0.00 | 0.00 | 0.00 | 0.00 | 0.00 | 0.00 | 0.00 |
| ZrO₂ | 4.37 | 3.82 | 3.63 | 3.65 | 4.37 | 4.37 | 4.26 |
| Total | 100.00 | 100.00 | 100.00 | 100.00 | 100.00 | 100.00 | 100.00 |

Properties

| | | | | | | | |
|---|---|---|---|---|---|---|---|
| n_{d} | 1.987 | 1.988 | 1.992 | 1.992 | 1.987 | 1.982 | 1.991 |
| v_{d} | 20.3 | 20.2 | 20.8 | 20.6 | 20.5 | 20.4 | 21.0 |
| Density [g/cm³] | 3.66 | 3.65 | 3.72 | 3.72 | 3.68 | 3.67 | 3.70 |

TABLE 3

| mol % | 15 | 16 | 17 | 18 | 19 | 20 | 21 |
|---|---|---|---|---|---|---|---|
| B₂O₃ | 0.00 | 0.00 | 0.00 | 0.00 | 0.00 | 0.00 | 0.00 |
| BaO | 8.47 | 8.52 | 8.31 | 8.36 | 4.42 | 8.31 | 3.38 |
| TiO₂ | 49.87 | 50.11 | 48.39 | 48.87 | 45.46 | 49.03 | 48.73 |
| Nb₂O₅ | 0.00 | 0.00 | 0.00 | 0.00 | 0.00 | 0.00 | 0.00 |
| SiO₂ | 18.33 | 18.16 | 20.17 | 19.02 | 19.53 | 18.39 | 19.47 |
| Al₂O₃ | 0.00 | 0.00 | 0.00 | 0.00 | 0.00 | 0.00 | 0.00 |
| MgO | 0.00 | 0.00 | 0.00 | 0.00 | 5.85 | 0.00 | 1.31 |
| CaO | 6.28 | 5.84 | 11.37 | 9.29 | 14.57 | 9.44 | 12.94 |
| Li₂O | 0.59 | 0.00 | 0.00 | 0.46 | 0.00 | 0.00 | 0.00 |
| Na₂O | 10.24 | 10.89 | 7.02 | 7.99 | 5.57 | 8.78 | 8.82 |
| K₂O | 0.94 | 0.95 | 0.00 | 0.84 | 0.00 | 0.66 | 0.56 |
| ZnO | 0.94 | 0.95 | 0.84 | 0.93 | 1.17 | 1.13 | 1.13 |
| SrO | 0.00 | 0.00 | 0.00 | 0.00 | 0.00 | 0.00 | 0.00 |
| As₂O₃ | 0.00 | 0.00 | 0.00 | 0.00 | 0.00 | 0.00 | 0.00 |
| Y₂O₃ | 0.00 | 0.24 | 0.00 | 0.00 | 0.00 | 0.00 | 0.00 |
| Sb₂O₃ | 0.00 | 0.00 | 0.00 | 0.00 | 0.00 | 0.00 | 0.00 |
| La₂O₃ | 0.00 | 0.00 | 0.26 | 0.00 | 0.00 | 0.00 | 0.00 |
| Gd₂O₃ | 0.00 | 0.00 | 0.00 | 0.00 | 0.00 | 0.00 | 0.00 |
| ZrO₂ | 4.34 | 4.36 | 3.64 | 4.25 | 3.42 | 4.26 | 3.67 |
| Total | 100.00 | 100.00 | 100.00 | 100.00 | 100.00 | 100.00 | 100.00 |

Properties

| | | | | | | | |
|---|---|---|---|---|---|---|---|
| n_{d} | 1.987 | 1.979 | 1.985 | 1.991 | 1.990 | 1.991 | 1.986 |
| v_{d} | 20.8 | 20.3 | 20.4 | 20.6 | 21.2 | 21 | 20.4 |
| Density [g/cm³] | 3.69 | 3.67 | 3.69 | 3.71 | 3.61 | 3.71 | 3.54 |

TABLE 4

| mol % | 22 | 23 | 24 | 25 | 26 | 27 | 28 |
|---|---|---|---|---|---|---|---|
| B₂O₃ | 0.00 | 0.00 | 0.00 | 0.00 | 0.00 | 1.57 | 0.00 |
| BaO | 3.39 | 3.41 | 3.41 | 2.08 | 0.00 | 8.30 | 7.35 |
| TiO₂ | 48.68 | 47.32 | 46.62 | 48.65 | 48.50 | 49.25 | 46.64 |
| Nb₂O₅ | 0.00 | 0.00 | 0.00 | 0.00 | 0.00 | 0.00 | 0.00 |
| SiO₂ | 18.39 | 20.67 | 21.42 | 19.37 | 19.17 | 17.74 | 21.61 |
| Al₂O₃ | 1.02 | 0.00 | 0.00 | 0.00 | 0.00 | 0.00 | 0.69 |
| MgO | 1.32 | 1.92 | 1.92 | 1.32 | 1.34 | 0.00 | 0.00 |
| CaO | 12.99 | 14.72 | 14.72 | 13.03 | 13.57 | 9.44 | 5.94 |
| Li₂O | 0.00 | 0.00 | 5.69 | 0.00 | 0.00 | 0.00 | 0.53 |
| Na₂O | 8.85 | 7.11 | 1.42 | 8.97 | 9.08 | 8.77 | 12.61 |
| K₂O | 0.56 | 0.00 | 0.00 | 0.47 | 0.48 | 0.66 | 0.00 |
| ZnO | 1.13 | 1.28 | 1.28 | 2.45 | 4.21 | 1.13 | 0.85 |
| SrO | 0.00 | 0.00 | 0.00 | 0.00 | 0.00 | 0.00 | 0.00 |
| As₂O₃ | 0.00 | 0.00 | 0.00 | 0.00 | 0.00 | 0.00 | 0.00 |
| Y₂O₃ | 0.00 | 0.00 | 0.00 | 0.00 | 0.00 | 0.00 | 0.00 |
| Sb₂O₃ | 0.00 | 0.00 | 0.00 | 0.00 | 0.00 | 0.00 | 0.00 |
| La₂O₃ | 0.00 | 0.00 | 0.00 | 0.00 | 0.00 | 0.00 | 0.00 |
| Gd₂O₃ | 0.00 | 0.00 | 0.00 | 0.00 | 0.00 | 0.00 | 0.00 |
| ZrO₂ | 3.66 | 3.56 | 3.51 | 3.66 | 3.65 | 3.14 | 3.78 |
| Total | 100.00 | 100.00 | 100.00 | 100.00 | 100.00 | 100.0 | 100.00 |

Properties

| | | | | | | | |
|---|---|---|---|---|---|---|---|
| n_{d} | 1.986 | 1.988 | 2.004 | 1.983 | 1.990 | 1.987 | 1.950 |
| v_{d} | 20.4 | 20.7 | 20.5 | 20.3 | 20.1 | 20.2 | 21.0 |
| Density [g/cm³] | 3.56 | 3.56 | 3.60 | 3.53 | 3.49 | 3.69 | 3.60 |

TABLE 5

| mol % | 29 | 30 | 31 | 32 | 33 | 34 | 35 |
|---|---|---|---|---|---|---|---|
| B₂O₃ | 0.00 | 0.00 | 3.50 | 6.84 | 0.00 | 0.00 | 0.00 |
| BaO | 6.98 | 8.48 | 8.05 | 14.53 | 8.48 | 7.89 | 0.00 |
| TiO₂ | 45.44 | 45.49 | 44.99 | 39.49 | 45.44 | 46.68 | 43.88 |
| Nb₂O₅ | 0.00 | 0.00 | 0.00 | 0.00 | 0.00 | 0.00 | 0.00 |
| SiO₂ | 19.74 | 24.05 | 16.34 | 13.68 | 23.83 | 22.75 | 26.76 |
| Al₂O₃ | 0.00 | 0.00 | 0.00 | 0.00 | 0.00 | 0.00 | 0.00 |
| MgO | 4.14 | 0.00 | 3.63 | 4.00 | 0.00 | 0.00 | 0.69 |
| CaO | 13.19 | 5.60 | 12.98 | 16.35 | 5.76 | 4.90 | 6.95 |
| Li₂O | 0.00 | 0.45 | 0.00 | 0.00 | 0.00 | 0.00 | 0.69 |
| Na₂O | 5.21 | 10.11 | 5.23 | 0.00 | 10.56 | 11.74 | 15.29 |
| K₂O | 0.33 | 0.80 | 0.33 | 0.00 | 0.80 | 0.88 | 1.39 |
| ZnO | 1.55 | 1.06 | 1.30 | 1.45 | 0.91 | 0.82 | 1.04 |
| SrO | 0.00 | 0.00 | 0.00 | 0.00 | 0.00 | 0.00 | 0.00 |
| As₂O₃ | 0.00 | 0.00 | 0.00 | 0.00 | 0.00 | 0.00 | 0.00 |
| Y₂O₃ | 0.00 | 0.00 | 0.00 | 0.00 | 0.00 | 0.00 | 0.00 |
| Sb₂O₃ | 0.00 | 0.00 | 0.00 | 0.00 | 0.00 | 0.00 | 0.00 |
| La₂O₃ | 0.00 | 0.00 | 0.00 | 0.00 | 0.00 | 0.00 | 0.00 |
| Gd₂O₃ | 0.00 | 0.00 | 0.00 | 0.00 | 0.00 | 0.00 | 0.00 |
| ZrO₂ | 3.42 | 3.96 | 3.65 | 3.67 | 4.22 | 4.34 | 3.30 |
| Total | 100.00 | 100.00 | 100.00 | 100.00 | 100.00 | 100.00 | 100.00 |

Properties

| | | | | | | | |
|---|---|---|---|---|---|---|---|
| n_{d} | 1.988 | 1.942 | 1.983 | 1.965 | 1.943 | 1.946 | 1.90 |
| v_{d} | 20.7 | 20.3 | 20.8 | 23 | 22.3 | 20.9 | 22.6 |
| Density [g/cm³] | 3.71 | 3.61 | 3.71 | 3.93 | 3.61 | 3.58 | 3.24 |

TABLE 6

| mol % | 36 | 37 | 38 | 39 | 40 | 41 | 42 |
|---|---|---|---|---|---|---|---|
| B₂O₃ | 1.14 | 0.00 | 3.75 | 4.61 | 0.00 | 0.00 | 4.926 |
| BaO | 8.02 | 1.14 | 13.66 | 14.59 | 7.91 | 7.43 | 16.285 |
| TiO₂ | 46.63 | 43.83 | 44.47 | 42.61 | 46.39 | 46.41 | 41.342 |
| Nb₂O₅ | 0.00 | 0.00 | 0.00 | 0.00 | 0.00 | 0.00 | 0.000 |
| SiO₂ | 20.44 | 24.05 | 17.48 | 17.14 | 21.42 | 23.17 | 11.942 |
| Al₂O₃ | 0.00 | 0.00 | 0.00 | 0.00 | 0.00 | 0.00 | 4.030 |
| MgO | 0.00 | 0.00 | 0.00 | 0.97 | 0.54 | 0.51 | 1.039 |
| CaO | 13.37 | 7.43 | 13.94 | 15.89 | 8.63 | 8.10 | 16.285 |
| Li₂O | 0.00 | 0.95 | 0.00 | 0.00 | 0.00 | 0.00 | 0.000 |
| Na₂O | 6.00 | 17.14 | 2.51 | 0.00 | 10.99 | 10.31 | 0.000 |
| K₂O | 0.00 | 0.95 | 0.00 | 0.00 | 0.00 | 0.00 | 0.000 |
| ZnO | 0.89 | 0.95 | 0.85 | 0.97 | 0.90 | 0.84 | 0.000 |
| SrO | 0.00 | 0.00 | 0.00 | 0.00 | 0.00 | 0.00 | 1.039 |
| As₂O₃ | 0.00 | 0.00 | 0.00 | 0.00 | 0.00 | 0.00 | 0.000 |
| Y₂O₃ | 0.00 | 0.00 | 0.00 | 0.00 | 0.00 | 0.00 | 0.000 |
| Sb₂O₃ | 0.00 | 0.00 | 0.00 | 0.00 | 0.00 | 0.00 | 0.000 |
| La₂O₃ | 0.00 | 0.00 | 0.00 | 0.00 | 0.00 | 0.00 | 0.000 |
| Gd₂O₃ | 0.00 | 0.00 | 0.00 | 0.00 | 0.00 | 0.00 | 0.000 |
| ZrO₂ | 3.51 | 3.55 | 3.35 | 3.21 | 3.22 | 3.23 | 3.112 |
| Total | 100.00 | 100.00 | 100.00 | 100.00 | 100.00 | 100.00 | 100.00 |

Properties

| | | | | | | | |
|---|---|---|---|---|---|---|---|
| n_{d} | 1.994 | 1.897 | 1.981 | 1.984 | 1.953 | 1.963 | 1.980 |
| v_{d} | 20.9 | 21.6 | 21.8 | 21.9 | 21.3 | 20.7 | 21.8 |
| Density [g/cm³] | 3.71 | 3.28 | 3.89 | 3.93 | 3.62 | 3.58 | 4.02 |

The glasses from the inventive examples have low density coupled with high refractive index and a favourable product of Abbe number and density, and have a low Tₘₐₓ. In the context of the invention, it has been found that the glasses according to the invention have a low tendency to crystallization.

Although the present invention has been described with reference to preferred exemplary embodiments, it is not limited thereto, and is modifiable in various ways.

1. An optical glass having a refractive index n_{d} of more than 1.85, an Abbe number v_{d} of less than 35 and a temperature Tₘₐₓ of not more than 1350° C., comprising at least SiO₂ and TiO₂, comprising less than 30.0 mol % of SiO₂, less than 2.0 mol % of Nb₂O₅, less than 17 mol % of BaO and less than 5.0 mol % of Ln₂O₃, where Ln₂O₃═Y₂O₃, La₂O₃, Gd₂O₃ and/or Yb₂O₃.

2. The optical glass of claim 1, wherein the glass has a molar ratio of (TiO₂+ZrO₂+2*Nb₂O₅+2*Ta₂O₅+2*Al₂O₃+SiO₂+B₂O₃)/(R₂O+RO+2*Ln₂O₃) of 1.5-3.5, where R₂O═Li₂O, Na₂O and/or K₂O and RO═MgO, CaO, SrO and/or BaO and Ln₂O₃═Y₂O₃, La₂O₃, Gd₂O₃ and/or Yb₂O₃.

3. The optical glass of claim 1, wherein the glass has a product of Abbe number v_{d} and density ρ of less than 120 g/cm³.

4. The optical glass of claim 1, wherein the glass is essentially free of Nb₂O₅.

5. The optical glass of claim 1, wherein the glass contains more than 0 mol % to 15.0 mol % of BaO.

6. The optical glass of claim 1, wherein the glass has a total content of BaO and TiO₂ of at least 35.0 mol % and/or not more than 70.0 mol %.

7. The optical glass of claim 1, wherein the glass has a total content of R₂O, where R₂O═Li₂O, Na₂O and/or K₂O, of 1.0 mol % to 20.0 mol %.

8. The optical glass of claim 1, wherein the glass has a total content of RO, where RO═MgO, CaO, SrO and/or BaO, of 8.0 mol % to 31.0 mol % and/or a total content of MgO, CaO and SrO of 2.0 mol % to 25.0 mol %.

9. The optical glass of claim 1, wherein the glass has a total content of RO+R₂O of 15.0 mol % to 40.0 mol %.

10. The optical glass of claim 1, wherein the glass contains from 0.5 mol % to 7.5 mol % of ZrO₂.

11. The optical glass of claim 1, wherein the glass includes less than 10.0 mol % of ZnO.

12. The optical glass of claim 1, wherein the glass comprises the following components in mol %:

| | |
|---|---|
| SiO₂ | 10.0-<30.0 |
| B₂O₃ | 0-8.0 |
| TiO₂ + BaO | 35.0-70.0 |
| R₂O + RO | 15.0-40.0 |
| ZnO | <10.0 |
| Ln₂O₃ | <2.0. |

13. The optical glass of claim 1, wherein the glass has a total content of SiO₂ and B₂O₃ of 12.0 mol % to 25.0 mol %.

14. The optical glass of claim 1, wherein the glass contains less than 5.0 mol % of K₂O.

15. The optical glass of claim 1, wherein the glass comprises the following components in mol %:

| | |
|---|---|
| SiO₂ | 10.0-<30.0 |
| B₂O₃ | 0-8.0 |
| TiO₂ + BaO | 35.0-70.0 |
| R₂O | 1.0-20.0 |
| RO | 8.0-31.0 |
| R₂O + RO | 15.0-40.0 |
| ZnO | ≤7.5 |
| ZrO2 | 0.5-7.5 |
| Ln₂O₃ | <1.0. |

16. The optical glass of claim 1, wherein the glass comprises the following components in mol %:

| | |
|---|---|
| SiO₂ | 12.0-28.0 |
| B₂O₃ | 0-5.0 |
| TiO₂ + BaO | 40.0-65.0 |
| TiO₂ | 35.0-65.0 |
| R₂O | 2.0-17.0 |
| Li₂O | 0-10.0 |
| Na₂O | 0.5-15.0 |
| K₂O | 0-5.0 |
| RO | 10.0-28.0 |
| MgO | 0-10.0 |
| CaO | 1.0-25.0 |
| SrO | 0-5.0 |
| BaO | 1.0-12.0 |
| R₂O + RO | 20.0-35.0 |
| ZnO | 0-5.5 |
| ZrO2 | 1.5-6.5 |
| Ln₂O₃ | <1.0. |

17. The optical glass of claim 1, wherein the glass has an internal transmittance of at least 80% measured at a wavelength of 460 nm and a sample thickness of 10 mm.

18. A glass article comprising the optical glass of claim 1, in the form of
a glass substrate, especially as a constituent of a stack of substrates for an optical component, especially in a pair of AR eyeglasses,
a wafer,
a lens, a rod lens, a prism or an asphere, and/or
an optical waveguide, especially a fibre or plate.
